(19) United States
(12) Patent Application Publication
(10) Pub. No.: US 2012/0050364 A1
(43) Pub. Date: Mar. 1, 2012

(54) PRINTING APPARATUS AND PROCESSING METHOD THEREFOR

(75) Inventors: Yoshiyuki Honda, Kawasaki-shi (JP); Atsushi Sakamoto, Kawasaki-shi (JP); Takeshi Murase, Yokohama-shi (JP); Minoru Teshigawara, Saitama-shi (JP)

(73) Assignee: CANON KABUSHIKI KAISHA, Tokyo (JP)

(21) Appl. No.: 12/964,101

(22) Filed: Dec. 9, 2010

(30) Foreign Application Priority Data
Sep. 1, 2010 (JP) 2010-196098

(51) Int. Cl. B41J 29/38

(52) U.S. Cl. 347/14

(57) ABSTRACT

A printing apparatus comprises: a control unit that controls to apply a voltage from a power supply unit to printing elements for respective groups each including a plurality of printing elements; a memory that stores, for the respective groups, accumulated times during which the voltage is applied; a obtaining unit that obtains the accumulated times for the respective groups; a measurement unit that measures, for the respective groups, voltage application times during which the voltage is applied for a predetermined time; a calculation unit that adds the voltage application times to the accumulated times; an updating processing unit that writes, in the memory, the accumulated times obtained for the respective groups by the addition; and an inhibition processing unit that performs processing for inhibiting use of a printhead when one of the accumulated times obtained for the respective groups by the addition has exceeded a predetermined time.

### BACKGROUND OF THE INVENTION

1. Field of the Invention

The present invention relates to a printing apparatus and processing method therefor.

2. Description of the Related Art

There has been conventionally known an inkjet printing apparatus which prints by abruptly heating ink by a heat generation element (heater) arranged in an inkjet printhead (to be simply referred to as a printhead) to generate a bubble, and discharging the ink from a nozzle by the pressure of the bubble.

In this printing apparatus, the heater is covered with a passivation film to prevent oxidization caused by direct contact of the heater with ink, and damage to the heater by a stress (cavitation) applied in defoaming.

However, this passivation film itself oxidizes after a predetermined period of use, and changes into a hard brittle material. If printing continues with the brittle passivation film, the passivation film itself may be damaged by cavitation. As a result, the heater may be damaged, failing to discharge ink.

To solve this, there is known a technique of cumulatively measuring a printed dot count history (to be referred to as a dot count) every time the printhead performs a discharge operation, and when the dot count exceeds a predetermined value, determining that the service life of the printhead has come to the end (Japanese Patent Laid-Open No. 2004-272545).

For a thermal transfer printing apparatus, there is known a technique of cumulatively measuring the energization time of a thermal head in printing, and when the accumulated energization time exceeds a predetermined value, determining that the service life of the printhead has come to the end (Japanese Patent Laid-Open No. 5-147250).

In these conventional techniques and the like, the service life of the printhead is resultantly estimated by integrating the energization time to the printhead. However, oxidization of the passivation film, degradation of the heater itself, disconnection of the heater line, and the like progress not only during the energization time when printing is done, but also during the time when voltage is applied although no printing is performed.

Hence, it is sometimes insufficient to set the accumulated energization time as an index for managing the durable service life of the printhead in an arrangement in which voltage supply ON/OFF control is performed for a plurality of chips or nozzles using one power supply unit, like a full-line printhead.

In this arrangement, the voltage is applied even to a chip or nozzle which does not discharge ink. Even if it is determined that the chip has not discharged the number of ink dots corresponding to the dot count-based durability limit, the durability limit of the heater may have come first owing to the voltage application, and the heater line may be disconnected.

### SUMMARY OF THE INVENTION

The present invention provides a technique of determining the durable service life of a printhead using an index obtained by accumulating the voltage application time for a predetermined number of nozzles.

According to a first aspect of the present invention, there is provided a printing apparatus which prints by energizing printing elements arranged in correspondence with respective nozzles and discharging ink from the respective nozzles, the apparatus comprising: a control unit configured to control to apply a voltage from a power supply unit to the printing elements for respective groups each including a plurality of printing elements; a memory configured to store, for the respective groups, accumulated times during which the voltage is applied; a first obtaining unit configured to obtain the accumulated times stored in the memory for the respective groups; a first measurement unit configured to measure, for the respective groups, voltage application times during which the voltage is applied for a predetermined time; a first calculation unit configured to add the voltage application times measured for the respective groups to the accumulated times obtained for the respective groups; an updating processing unit configured to write, in the memory, the accumulated times obtained for the respective groups by the addition performed by the first calculation unit; and an inhibition processing unit configured to perform processing for inhibiting use of a printhead when one of the accumulated times obtained for the respective groups by the addition performed by the first calculation unit has exceeded a predetermined time.

According to a second aspect of the present invention, there is provided a processing method of controlling a printing apparatus which prints by energizing printing elements arranged in correspondence with respective nozzles and discharging ink from the respective nozzles, the method comprising: applying a voltage from a power supply unit to the printing elements for respective groups each including a plurality of printing elements; storing, in a memory for the respective groups, accumulated times during which the voltage is applied; obtaining the accumulated times stored in the memory for the respective groups; measuring, for the respective groups, voltage application times during which the voltage is applied for a predetermined time; adding the voltage application times measured for the respective groups to the accumulated times obtained for the respective groups; writing, in the memory, the accumulated times of the respective groups to which the voltage application times are added; and performing processing for inhibiting use of a printhead when one of the accumulated times for the respective groups has exceeded a predetermined time.

Further features of the present invention will be apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a sectional view exemplifying the configuration of a printing system according to an embodiment of the present invention;

FIG. 2 is a view exemplifying the arrangement of a printhead 14 in a printing apparatus 20 shown in FIG. 1;

FIG. 3 is a block diagram exemplifying the functional arrangement of a controller 15 shown in FIG. 1;

FIG. 4 is a flowchart exemplifying a processing sequence in the printing apparatus 20 shown in FIG. 1;

FIG. 5 is a flowchart exemplifying a processing sequence in the printing apparatus 20 shown in FIG. 1;

FIG. 6 is a view exemplifying the structure of a control command;

FIG. 7 is a block diagram exemplifying the functional arrangement of a controller 15 according to the second embodiment; and

FIG. 8 is a flowchart exemplifying a processing sequence in a printing apparatus 20 according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

In this specification, “printing” means not only forming significant information such as characters or graphics but also forming, for example, an image, design, pattern, or structure on a printing medium in a broad sense regardless of whether the formed information is significant, or processing the medium as well. In addition, the formed information need not always be visualized so as to be visually recognized by humans.

Also, a “printing medium” means not only a paper sheet for use in a general printing apparatus but also a member which can fix ink, such as cloth, plastic film, metallic plate, glass, ceramics, resin, lumber, or leather in a broad sense.

Also, “ink” should be interpreted in a broad sense as in the definition of “printing” mentioned above, and means a liquid which can be used to form, for example, an image, design, or pattern, process a printing medium, or perform ink processing upon being supplied onto the printing medium. The ink processing includes, for example, solidification or insolubilization of a coloring material in ink supplied onto a printing medium.

Furthermore, “nozzle” generally means a set of an orifice, a liquid channel communicating with the orifice, and an element which generates energy utilized for ink discharge, unless otherwise stated.

### First Embodiment

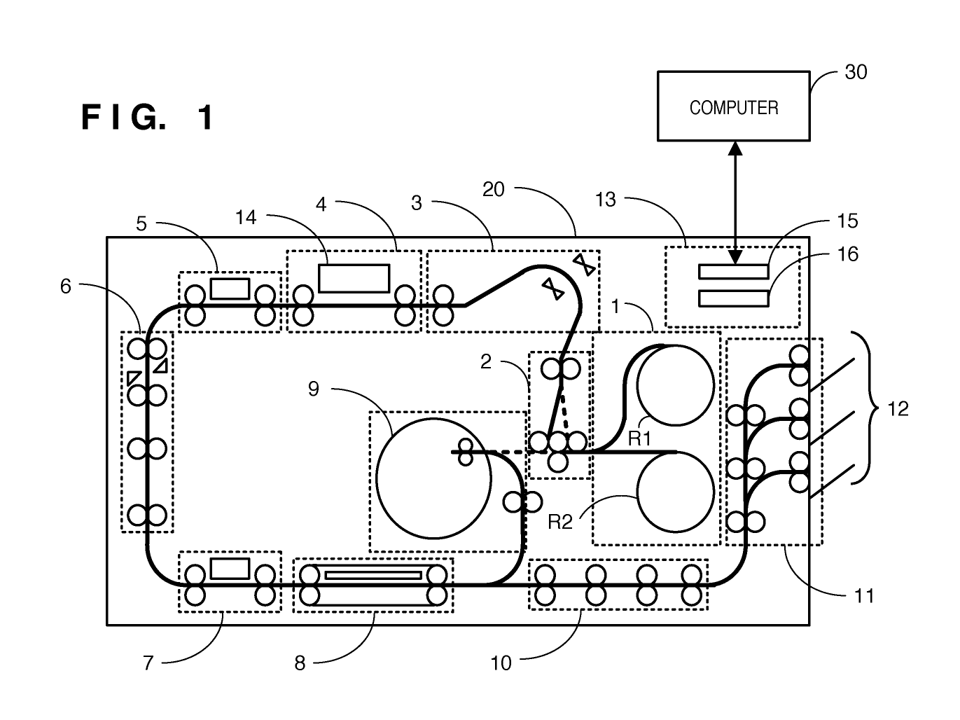

FIG. 1 is a sectional view exemplifying the configuration of a printing system according to an embodiment of the present invention.

The printing system includes a personal computer 30 and printing apparatus 20.

The personal computer (to be simply referred to as a computer) 30 has a function of supplying image data. The computer includes a main control means such as a CPU, and storage means such as a ROM (Read Only Memory), RAM (Random Access Memory), and HDD (Hard Disk Drive). The computer may also include input/output means such as a keyboard and mouse, and a communication means such as a network card. These building components are connected by a bus or the like, and controlled by executing a program stored in the storage means by the main control means.

The printing apparatus 20 has a function of printing an image on a printing medium based on image data sent from the computer 30. In the first embodiment, the printing apparatus 20 adopts an inkjet method and can print on a roll-like printing medium (roll paper).

The printing apparatus 20 incorporates a sheet supply unit 1, decurling unit 2, skew correction unit 3, printing unit 4, inspection unit 5, cutter unit 6, information printing unit 7, drying unit 8, sheet take-up unit 9, and discharge conveyance unit 10. In addition, the printing apparatus 20 incorporates a sorter unit 11, discharge trays 12, and a control unit 13.

A conveyance mechanism made up of roller pairs and a belt conveys a printing medium (sheet) along a conveyance path (indicated by solid lines in FIG. 1). The sheet supply unit 1 stores a sheet wound like a roll. The decurling unit 2 reduces the curl (warpage) of a sheet supplied from the sheet supply unit 1. The skew correction unit 3 corrects the skew (tilt from an original traveling direction) of the sheet having passed through the decurling unit 2. The printing unit 4 prints an image on the conveyed sheet. The printing unit 4 includes a plurality of inkjet printheads (to be simply referred to as printheads) 14. Each printhead 14 is a full-line printhead, and has a printing width corresponding to the maximum width of a sheet, the use of which is assumed.

The inspection unit 5 optically reads a pattern or image printed on a sheet, and inspects the nozzle state of the printhead 14, the sheet conveyance state, the image position, and the like. The cutter unit 6 cuts a sheet into a predetermined length. The information printing unit 7 prints information such as a serial number and date on the reverse of a sheet. The drying unit 8 heats a sheet to dry ink on it (within a short time). The sheet take-up unit 9 temporarily takes up a continuous sheet having undergone printing on the obverse of a sheet in double-sided printing. The discharge conveyance unit 10 conveys a sheet to the sorter unit 11. The sorter unit 11 discharges sheets while sorting them to the different discharge trays 12. The control unit 13 controls the respective units of the printing apparatus 20. The control unit 13 includes a controller 15 having a CPU, memories (ROM and RAM), various I/O interfaces, and the like, and a power supply unit 16.

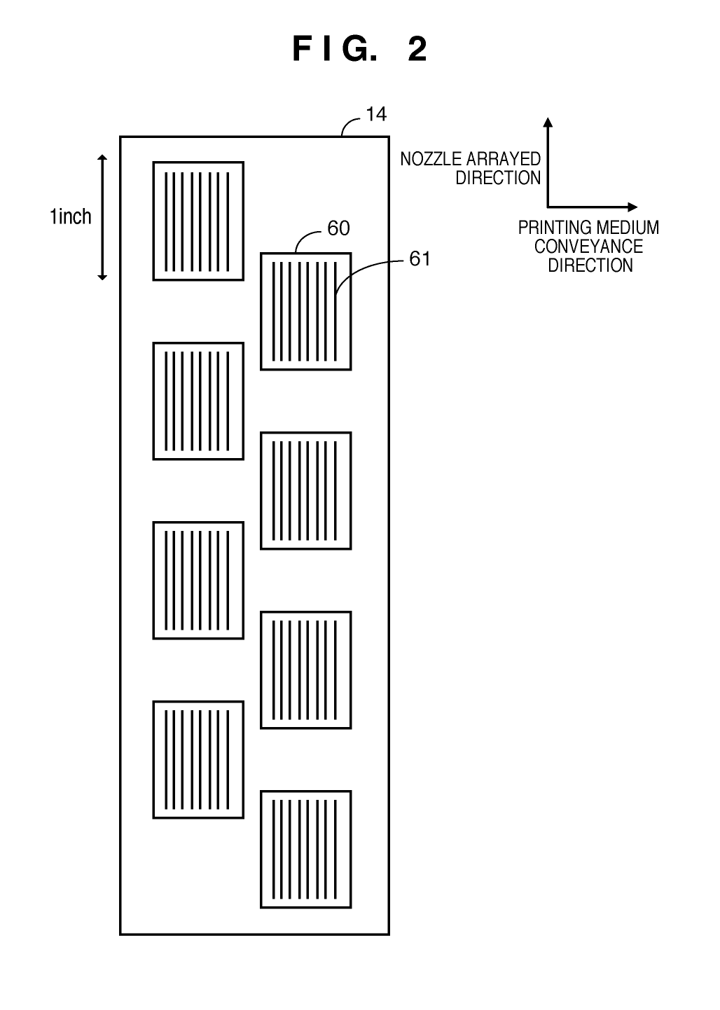

The arrangement of the printhead 14 in the printing apparatus 20 shown in FIG. 1 will be exemplified with reference to FIG. 2. The respective printheads have the same arrangement, so only one of them will be exemplified.

The printheads 14 are printheads for four, black (K), cyan (C), magenta (M), and yellow (Y).

In the printhead 14, for example, eight silicon chips 31 to 38 each having an effective discharge width of about 1 inch are staggered on a base substrate (support member). The chip is electrically connected to a flexible wiring board by wire bonding via electrodes at two ends in the nozzle arrayed direction.

The printhead 14 incorporates, for example, a non-volatile memory (ROM 62 to be described later). Similar to the chip, the non-volatile memory is electrically connected to the flexible wiring board. The printhead 14 has an effective discharge width of about 8 inches, which almost coincides with the length of the short side of an A4 printing sheet. By 1-pass scanning, the printhead 14 can complete printing of an image.

On each chip 60, a plurality of nozzle arrays 61 each having a plurality of nozzles are arranged. For each nozzle (orifice), a printing element (heater) formed from, for example, a heat generation element is arranged. The printing element heats a liquid by energization to bubble it, and discharges it from an orifice by the kinetic energy.

Each printing element is driven by supplying a voltage (energization) from the power supply unit 16 arranged in the control unit 13 shown in FIG. 1. The first embodiment will explain a case in which the voltage is uniformly supplied to a predetermined number of chips among a plurality of chips. Note that the voltage supply to the printing element may be ON/OFF-controlled for each nozzle in the chip by using a DC-DC converter or the like. However, voltage control for each nozzle is almost impossible owing to the apparatus arrangement. It is therefore practical to adopt an arrangement in which the voltage is uniformly supplied to a predetermined number of chips.

The controller 15 monitors the voltage supply ON/OFF state for each minimum unit (in the embodiment, a predetermined number of chips in the printhead) in which the printhead 14 undergoes voltage control. By this operation, the controller 15 measures the voltage application time of the printhead 14.

Note that the embodiment will exemplify a printing system for four, C, M, Y, and K. However, many other inks are also available, including light cyan ink, light magenta ink, red ink, and green ink. The printing apparatus may also be a monochrome one.

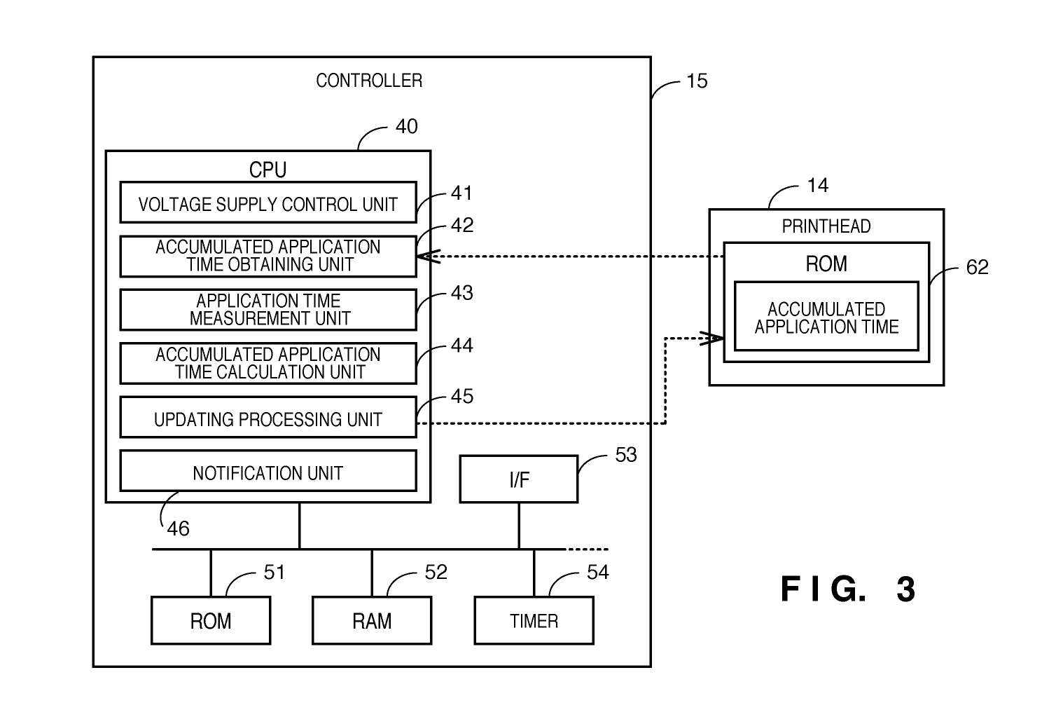

A functional arrangement in the controller 15 shown in FIG. 1 will be exemplified with reference to FIG. 3.

The controller 15 includes a CPU 40, ROM 51, RAM 52, I/F 53, and timer 54. The CPU 40 comprehensively controls processes in the printing apparatus 20. The ROM 51 stores programs and the like. The RAM 52 is used as a work area and the like, and stores an accumulated application time (to be described later) or the like. The I/F 53 is a communication interface which connects an external device (for example, the computer 30) and the printing apparatus 20. The timer 54 counts down the timer value.

A functional arrangement implemented by the CPU 40 will be exemplified. As the functional arrangement, the CPU 40 implements a voltage supply control unit 41, accumulated application time obtaining unit 42, application time measurement unit 43, accumulated application time calculation unit 44, updating processing unit 45, and notification unit 46. The CPU 40 implements these building components by loading programs stored in the ROM 51 using the RAM 52 as a work area.

The voltage supply control unit 41 controls to apply, to a printing element at each nozzle, a voltage supplied from the power supply unit 16. This control is executed for a predetermined number of chips in the printhead 14. Thus, the voltage supply ON/OFF state is controlled for a predetermined number of chips in the printhead 14.

The accumulated application time obtaining unit 42 functions as the first obtaining unit, and obtains an accumulated application time (accumulated time during which the voltage is applied) from the built-in ROM 62 of the printhead 14. Note that the ROM 62 stores the accumulated application time for a predetermined number of chips.

The application time measurement unit 43 functions as the first measurement unit, and measures, for a predetermined number of chips, the application time (voltage application time) of the voltage to the printing element for a predetermined time (from power-on to power-off in the embodiment). This measurement is performed by monitoring the voltage supply ON/OFF state by the voltage supply control unit 41 for a predetermined number of chips.

The accumulated application time calculation unit 44 functions as the first calculation unit, and adds the voltage application time measured by the application time measurement unit 43 to the accumulated application time obtained by the accumulated application time obtaining unit 42. This addition is performed for a predetermined number of chips.

The updating processing unit 45 writes, in the built-in ROM 62 of the printhead 14, the added accumulated application time obtained by addition by the accumulated application time calculation unit 44. This updating processing is executed at every predetermined time interval in accordance with count-down of the timer value of the timer 54.

The notification unit 46 determines whether one of added accumulated application times obtained by addition by the accumulated application time calculation unit 44 has exceeded a time limit (voltage application time limit) indicating the durable service life of the printhead 14. If even one added accumulated application time has exceeded the time limit, the notification unit 46 outputs a printhead exchange signal. In response to this, an operator panel (not shown) or the like displays information indicating that the durable service life of the printhead has come to the end. From this display, the user can grasp the printhead exchange time.

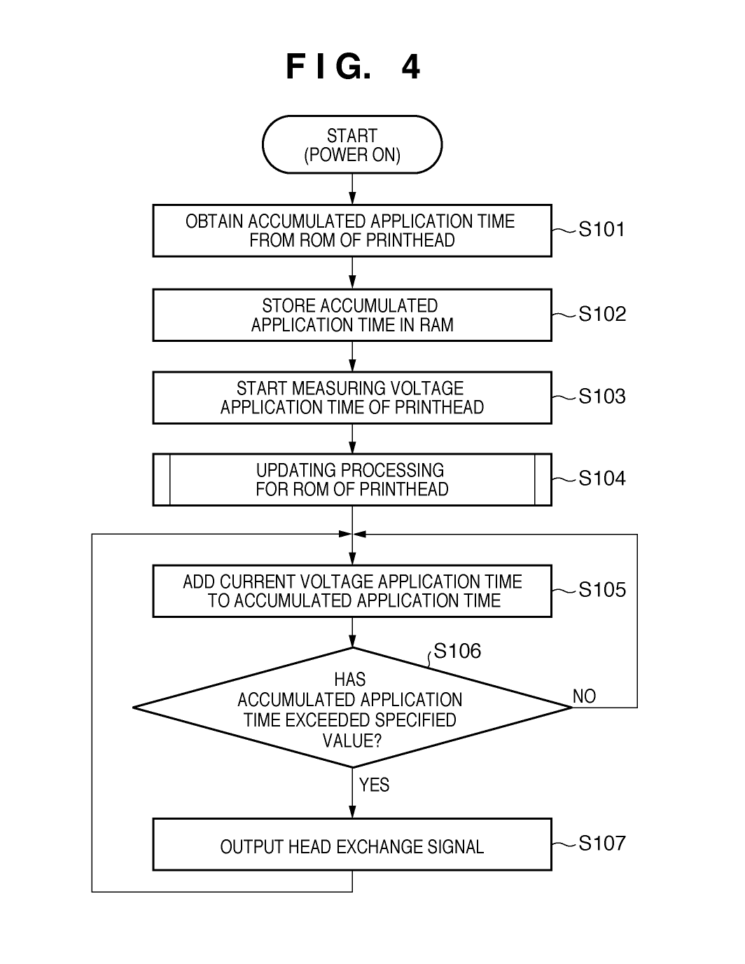

A processing sequence in the printing apparatus 20 shown in FIG. 1 will be exemplified with reference to FIG. 4. An operation of determining the durable service life of the printhead by monitoring the voltage application time of the printhead for a predetermined number of chips will be explained.

Note that one control for one block of chips in the printhead will be described. In practice, however, the processing shown in FIG. 4 is executed simultaneously for all blocks in all printheads mounted in the printing apparatus 20. In the first embodiment, voltage supply is controlled for a predetermined number of chips, so the minimum block unit for managing the durable service life of the printhead is a predetermined number of chips in the printhead.

First, the printhead 14 is attached while the main power supply of the printing apparatus 20 is OFF. After attaching the printhead 14, the main power supply of the printing apparatus 20 is turned on. After power-on, the printing apparatus 20 causes the accumulated application time obtaining unit 42 to obtain an accumulated application time from the ROM 62 in the printhead 14 (S101), and stores it in the RAM 52 of the apparatus main body (S102).

The printing apparatus 20 causes the application time measurement unit 43 to start measuring the voltage application time (S103). More specifically, the time during which the power supply unit 16 supplies a voltage to a target block (predetermined number of chips) in the printhead 14 is measured.

Then, the printing apparatus 20 causes the updating processing unit 45 to update the accumulated application time. Although details of this processing will be described later, the updating processing unit 45 overwrites, in the internal ROM 62 of the printhead 14 at every predetermined time interval, the accumulated application time stored in the RAM 52 of the apparatus main body (S104).

The printing apparatus 20 causes the accumulated application time calculation unit 44 to add the time (voltage application time) measured by the application time measurement unit 43 to the accumulated application time obtained from the printhead 14, thereby obtaining the current accumulated application time (S105).

The printing apparatus 20 causes the notification unit 46 to determine whether the accumulated application time obtained in the process of S105 has exceeded a specified value (voltage application time limit). Note that the voltage application time limit indicates the durable service life of the printhead, and is determined in advance based on the printhead performance and the like.

If the notification unit 46 determines that the accumulated application time has not exceeded the voltage application time limit (NO in S106), the printing apparatus 20 returns to the process in S105. Since the voltage application time remains measured in S103, the processes in S105 and S106 are repetitively executed based on the current voltage application time obtained by the measurement.

If the notification unit 46 determines in S106 that the accumulated application time has exceeded the voltage application time limit (YES in S106), the printing apparatus 20 causes the notification unit 46 to output a printhead exchange signal (S107). This is because a printhead including a predetermined number of target chips is supposed to have come to the durability limit. In the printing apparatus 20, the operator panel (not shown) or the like displays information to this effect. The user can grasp the printhead exchange time. Thereafter, the printing apparatus 20 returns again to the process in S105 to repetitively execute the above-described processes.

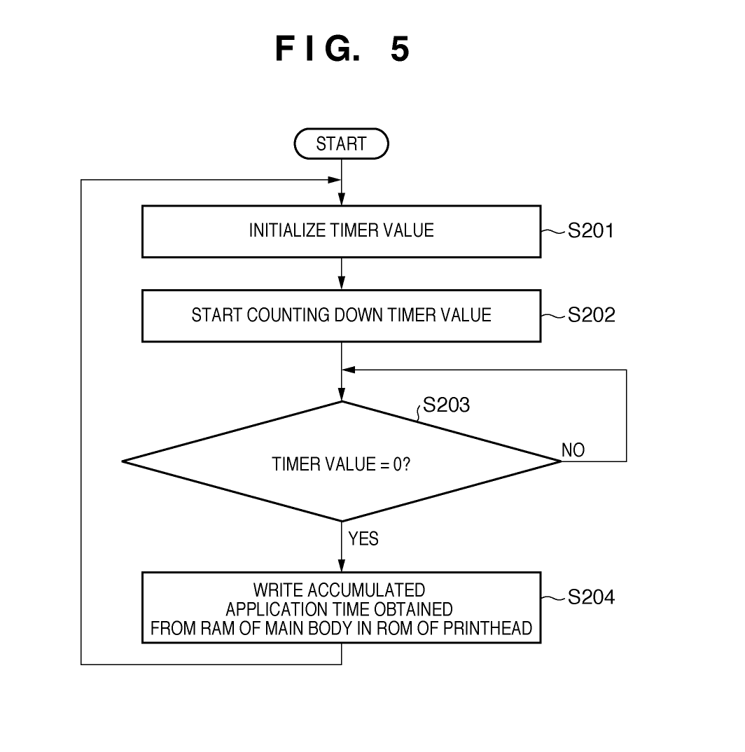

The process in S104 shown in FIG. 4 will be described with reference to FIG. 5. That is, an operation of updating the accumulated application time in the internal ROM 62 of the printhead will be explained.

After the start of this process, the printing apparatus 20 causes the timer 54 to initialize the timer value (S201), and start counting down the timer value (S202). Count-down continues until the timer value becomes 0.

If the printing apparatus 20 determines that the timer value becomes 0 (YES in S203), the updating processing unit 45 obtains the accumulated application time stored in the RAM 52 of the apparatus main body, and writes the information in the ROM 62 of the printhead 14 (S204), thereby updating the accumulated application time stored in the ROM 62 of the printhead 14. The printing apparatus 20 returns again to the process in S201 to repetitively execute the foregoing processes.

Even if, for example, the timer value cannot be updated in the ROM 62 of the printhead 14 owing to sudden power-off or the like, it is desirably set to a value at which the durable service life of the printhead can be almost accurately estimated with respect to the voltage application time limit of the printhead 14. The timer value is desirably set in consideration of even the communication load by write in the ROM 62 of the printhead 14.

As described above, according to the first embodiment, voltage supply ON/OFF control is performed for a predetermined number of chips in the printhead using one power supply unit. In this arrangement, the accumulated application time is obtained for the predetermined number of chips, and the durable service life of the printhead is determined based on the time.

In the arrangement in which voltage supply ON/OFF control is done for a predetermined number of chips, the voltage is uniformly applied to even a nozzle whose dot count is not incremented. For this reason, when the durable service life of the printhead is determined based on only the dot count, like a conventional technique, the durable service life of the printhead may come to the end depending on a printed image even if the accumulated printed dot count has not reached a durability limit value.

To the contrary, the control according to the first embodiment is free from this problem because the voltage application time is monitored for a predetermined number of chips to determine the durable service life of the printhead.

In the control according to the first embodiment, the accumulated application time is written in the built-in ROM of the printhead at every predetermined time interval. Even when the printhead is exchanged and reused in another main body, its durable service life can be accurately determined.

### Second Embodiment

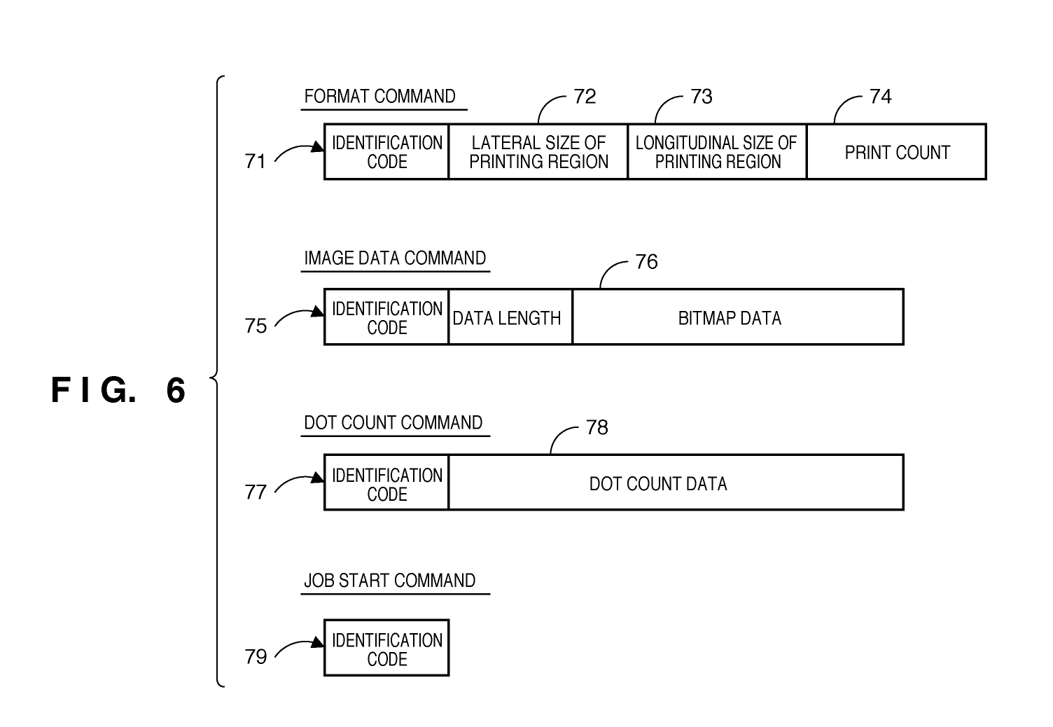

The second embodiment will be described next. The structure of a control command transmitted from a computer 30 to a printing apparatus 20 shown in FIG. 1 will be exemplified with reference to FIG. 6.

The control commands are, for example, a format command 71, image data command 75, dot count command 77, and job start command 79. The computer 30 transmits these commands to the printing apparatus. Each command contains an identification code for identifying the command by the printing apparatus 20.

The format command 71 indicates the start of image data to be printed. The format command 71 contains data 72 of the lateral (nozzle arrayed direction) size of a printing region to be actually printed on a printing medium, data 73 of the longitudinal (printing medium conveyance direction) size of the printing region, and print count data 74.

The image data command 75 contains bitmap image data (bitmap data) 76. The dot count command 77 contains dot count data 78 indicating the total number (dot count value) of dots to be discharged from each nozzle of the printhead when printing the bitmap data 76.

The job start command 79 contains only an identification code, which designates the end of print data and the start of a print job. In accordance with the dot count command 77, the printing apparatus 20 counts printed dots for each chip or nozzle of a printhead 14.

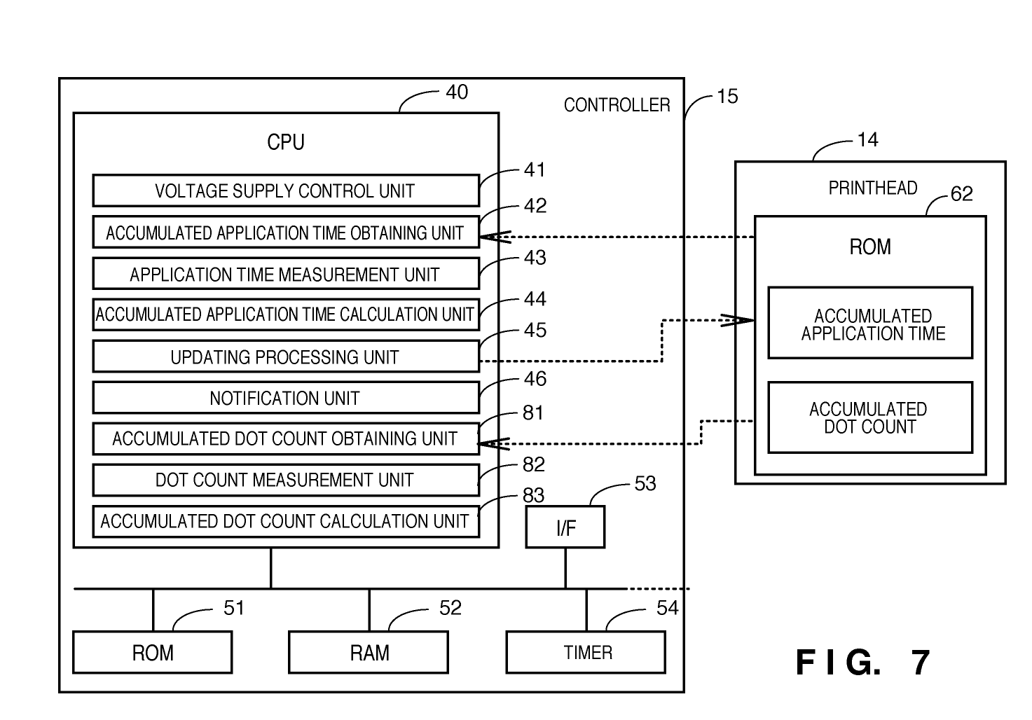

A functional arrangement in a controller 15 according to the second embodiment will be exemplified with reference to FIG. 7. Note that the same reference numerals as those in FIG. 3 described in the first embodiment denote the same functions, and a description of some functions will not be repeated.

As the functional arrangement, a CPU 40 implements an accumulated dot count obtaining unit 81, dot count measurement unit 82, and accumulated dot count calculation unit 83, in addition to the functional arrangement in the first embodiment.

The accumulated dot count obtaining unit 81 functions as the second obtaining unit, and obtains an accumulated dot count (accumulated printed dot count) from a built-in ROM 62 of the printhead 14. Note that the ROM 62 stores the accumulated dot count for a predetermined number of chips.

The dot count measurement unit 82 functions as the second measurement unit, and measures, for a predetermined number of chips, an actually printed dot count. This measurement is performed based on the dot count command 77 shown in FIG. 6.

The accumulated dot count calculation unit 83 functions as the second calculation unit, and adds the dot count measured by the dot count measurement unit 82 to the accumulated dot count obtained by the accumulated dot count obtaining unit 81. This addition is done for a predetermined number of chips.

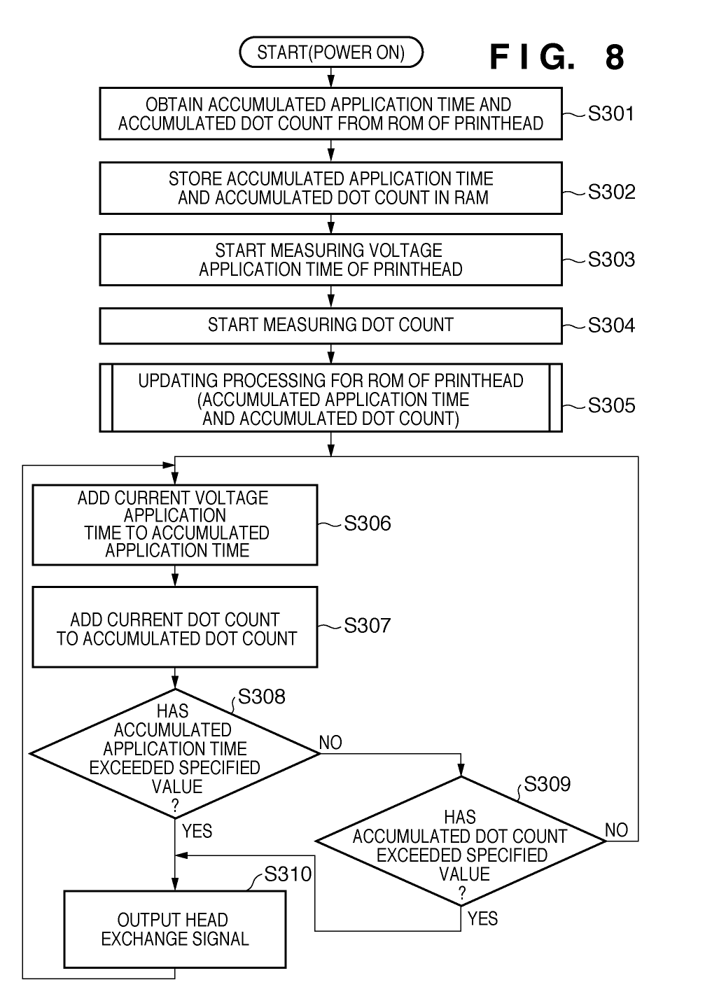

A processing sequence in the printing apparatus 20 according to the second embodiment will be exemplified with reference to FIG. 8. An operation of determining the durable service life of the printhead by monitoring the voltage application time of the printhead and the dot count (printed dot count) for a predetermined number of chips will be explained.

Note that one control for one block of chips in the printhead will be described. In practice, however, the processing shown in FIG. 8 is executed simultaneously for all blocks in all printheads mounted in the printing apparatus 20. In the second embodiment, voltage supply is controlled for a predetermined number of chips, so the minimum block unit for managing the durable service life of the printhead is a predetermined number of chips in the printhead. Since printed dots can be counted even for each nozzle, the minimum control unit may be one chip or nozzle (for each chip or nozzle).

First, the printhead 14 is attached while the main power supply of the printing apparatus 20 is OFF. After attaching the printhead 14, the main power supply of the printing apparatus 20 is turned on. Then, the printing apparatus 20 causes an accumulated application time obtaining unit 42 to obtain an accumulated application time from the ROM 62 in the printhead 14, and causes the accumulated dot count obtaining unit 81 to obtain an accumulated dot count from the ROM 62 in the printhead 14 (S301). The printing apparatus 20 stores the pieces of obtained information in a RAM 52 of the apparatus main body (S302).

The printing apparatus 20 causes an application time measurement unit 43 to start measuring the voltage application time (S303). More specifically, the time during which a power supply unit 16 supplies a voltage to a target block (predetermined number of chips) in the printhead 14 is measured. The printing apparatus 20 causes the dot count measurement unit 82 to start measuring an actually printed dot count (S304). As described above, this measurement is done based on the dot count command 77 shown in FIG. 6.

Then, the printing apparatus 20 causes an updating processing unit 45 to update the accumulated application time and accumulated dot count. More specifically, the accumulated application time and accumulated dot count stored in the RAM 52 of the apparatus main body are updated by overwrite in the internal ROM 62 of the printhead 14 at every predetermined time interval (S305). Note that this processing is the same as that in the first embodiment, and a detailed description thereof using the drawing will not be repeated. The difference from the first embodiment is that the accumulated dot count is also written in addition to the accumulated application time in the process of S204 shown in FIG. 5.

The printing apparatus 20 causes an accumulated application time calculation unit 44 to add the time (voltage application time) measured by the application time measurement unit 43 to the accumulated application time obtained from the printhead 14, thereby obtaining the current accumulated application time (S306). The printing apparatus 20 causes the accumulated dot count calculation unit 83 to add the printed dot count (dot count) measured by the dot count measurement unit 82 to the accumulated dot count obtained from the printhead 14, thereby obtaining the current accumulated dot count (S307).

After that, the printing apparatus 20 causes a notification unit 46 to determine whether the accumulated application time obtained in the process of S306 has exceeded a specified value (voltage application time limit). If the accumulated application time has exceeded the voltage application time limit (YES in S308), the notification unit 46 outputs a printhead exchange signal (S310). If the accumulated application time has not exceeded the voltage application time limit (NO in S308), the printing apparatus 20 causes the notification unit 46 to determine whether the accumulated dot count obtained in the process of S307 has exceeded a specified value (dot count limit).

If the notification unit 46 determines that the accumulated dot count has exceeded the dot count limit (YES in S309), the printing apparatus 20 causes the notification unit 46 to output a printhead exchange signal (S310). If the notification unit 46 determines that the accumulated dot count has not exceeded the dot count limit (NO in S309), the printing apparatus 20 returns to the process in S306. Note that the measurement processes in S303 and S304 remain executed. Based on the current voltage application time and dot count obtained by these measurement processes, the processes in S306 to S310 are repetitively executed.

As described above, according to the second embodiment, the durable service life of the printhead is determined using not only the accumulated application time but also the accumulated dot count. By either control, the durable service life of the printhead can be determined more accurately.

In the control according to the second embodiment, the accumulated application time and accumulated dot count are written in the built-in ROM of the printhead at every predetermined time interval. Even when the printhead is exchanged and reused in another main body, its durable service life can be accurately determined.

Typical embodiments of the present invention have been exemplified. However, the present invention is not limited to the above-described and illustrated embodiments, and can be properly changed and modified without departing from the scope of the invention.

For example, in the first and second embodiments, the voltage application time of the printhead is measured by monitoring the ON/OFF state of voltage supply from the power supply unit 16 to the printhead 14. However, the present invention is not limited to this. For example, the printhead generally has a cap mechanism to prevent drying of the nozzle. The cap mechanism caps the orifice surface of the nozzle when no ink is discharged, and opens it when discharging ink. By monitoring the time during which the cap mechanism is open, the voltage application time may be measured. Note that voltages supplied to the printhead are a control logic voltage, and a driving voltage directly contributing to discharge. The logic voltage is uniformly applied to the printhead when, for example, the main power supply is ON. Thus, it is preferable to measure the application time for only the driving voltage.

In the first and second embodiments, the control shown in FIG. 4 or 8 is performed for a predetermined number of chips. However, the control unit is not limited to this and may be, for example, a predetermined number of nozzles.

The first and second embodiments have exemplified a printing apparatus using roll paper. However, the printing medium used in printing is not limited to roll paper and is an arbitrary one such as a cut sheet.

The first and second embodiments have exemplified a printing apparatus in which a full-line printhead is mounted, but the printhead structure is not limited to this as long as the printhead receives a voltage for a predetermined number of nozzles.

The first and second embodiments have exemplified an arrangement in which the voltage supply and the durable service life of the printhead are managed for a predetermined number of chips (predetermined number of nozzles). However, the unit (number of chips or nozzles) for managing the voltage supply and durable service life may not be constant. For example, when a plurality of nozzles of the printhead are divided into a plurality of groups, and the voltage supply and durable service life are managed for each group, the number of nozzles belonging to each group can be changed.

In the first and second embodiments, when the accumulated application time has exceeded the voltage application time limit, a printhead exchange signal is output. However, the present invention is not limited to this arrangement. For example, when the printing apparatus includes a plurality of printheads for the same color, and the accumulated application time of one printhead has exceeded the voltage application time limit, it may be controlled to print using only the remaining printheads. In any case, when the accumulated application time of a printhead has exceeded the voltage application time limit, it suffices to perform the process of inhibiting the use of this printhead.

As described above, according to the present invention, the durable service life of the printhead is determined using an index obtained by accumulating the voltage application time for a predetermined number of nozzles. The durable service life of the printhead can be determined with a higher accuracy than by a conventional arrangement.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-196098 filed on Sep. 1, 2010, which is hereby incorporated by reference herein in its entirety.

What is claimed is:

1. A printing apparatus which prints by energizing printing elements arranged in correspondence with respective nozzles and discharging ink from the respective nozzles, the apparatus comprising:
a control unit configured to control to apply a voltage from a power supply unit to the printing elements for respective groups each including a plurality of printing elements;
a memory configured to store, for the respective groups, accumulated times during which the voltage is applied;
a first obtaining unit configured to obtain the accumulated times stored in said memory for the respective groups;
a first measurement unit configured to measure, for the respective groups, voltage application times during which the voltage is applied for a predetermined time;
a first calculation unit configured to add the voltage application times measured for the respective groups to the accumulated times obtained for the respective groups;
an updating processing unit configured to write, in said memory, the accumulated times obtained for the respective groups by said addition performed by said first calculation unit; and
an inhibition processing unit configured to perform processing for inhibiting use of a printhead when one of the accumulated times obtained for the respective groups by the addition performed by said first calculation unit has exceeded a predetermined time.

2. The apparatus according to claim 1, wherein
said memory stores, for the respective groups, printed dot counts accumulated upon printing,
the printing apparatus further comprises:
a second obtaining unit configured to obtain the accumulated printed dot counts stored in said memory for the respective groups;
a second measurement unit configured to measure, for the respective groups, dot counts printed in printing; and
a second calculation unit configured to add the printed dot counts measured for the respective groups to the accumulated printed dot counts obtained for the respective groups,
said updating processing unit writes, in said memory, the accumulated times obtained for the respective groups by the addition performed by said first calculation unit, and the accumulated printed dot counts obtained for the respective groups by the addition performed by said second calculation unit, and
said inhibition processing unit performs the processing for inhibiting use of the printhead when one of the accumulated times obtained for the respective groups by the addition performed by said first calculation unit has exceeded the predetermined time, or when one of the accumulated printed dot counts obtained for the respective groups by the addition performed by said second calculation unit has exceeded a predetermined dot count.

3. The apparatus according to claim 1, wherein said first measurement unit measures the voltage application time by monitoring a voltage from the power supply unit to the printing element.

4. The apparatus according to claim 1, further comprising a cap mechanism configured to cap an orifice surface of the nozzle,
wherein said first measurement unit measures the voltage application time by monitoring a time during which the orifice surface is open from said cap mechanism.

5. The apparatus according to claim 1, wherein
the printhead is formed by arranging a plurality of chips, on each of which a plurality of nozzles are arranged, and
printing elements belonging to the group are printing elements arranged on a predetermined number of chips among the plurality of chips.

6. The apparatus according to claim 1, wherein the numbers of printing elements belonging to the respective groups are equal.

7. The apparatus according to claim 1, wherein said inhibition processing unit comprises a notification unit configured to notify exchange of the printhead.

8. A processing method of controlling a printing apparatus which prints by energizing printing elements arranged in correspondence with respective nozzles and discharging ink from the respective nozzles, the method comprising:
applying a voltage from a power supply unit to the printing elements for respective groups each including a plurality of printing elements;
storing, in a memory for the respective groups, accumulated times during which the voltage is applied;
obtaining the accumulated times stored in the memory for the respective groups;
measuring, for the respective groups, voltage application times during which the voltage is applied for a predetermined time;
adding the voltage application times measured for the respective groups to the accumulated times obtained for the respective groups;
writing, in the memory, the accumulated times of the respective groups to which the voltage application times are added; and
performing processing for inhibiting use of a printhead when one of the accumulated times for the respective groups has exceeded a predetermined time.
